(19) United States
(12) Patent Application Publication
(10) Pub. No.: US 2012/0260513 A1
(43) Pub. Date: Oct. 18, 2012

(54) Tape Measure Carrier

(76) Inventors: William Daugherty, Central City, KY (US); Deborah Daugherty, Central City, KY (US)

(21) Appl. No.: 13/271,142

(22) Filed: Oct. 11, 2011

Related U.S. Application Data
(60) Provisional application No. 61/392,989, filed on Oct. 14, 2010.

(51) Int. Cl. G01B 3/10

(52) U.S. Cl. 33/758

(57) ABSTRACT

A tape measure holder device is provided, having the ability to be positioned on a belt of a user for easy access or replacement thereof. The device comprises a base plate, a horizontal attachment shelf, two guide mounts and a belt attachment means. The belt attachment means comprises two vertical clips, or alternatively a loop adapted to fit a user belt therethrough comprising a rigid loop or a larger, flexible loop for use with a carpenter's belt. A tape measure is secured using its attachment clip, which slides over the horizontal attachment shelf between the two opposing guide mounts, securing the clip between the shelf and the base plate. To remove the tape measure, a user slides the tape measure vertically from the horizontal shelf. An offset is provided by the attachment shelf that facilitates easy removal and replacement of the tape measure during operation.

### CROSS REFERENCE TO RELATED APPLICATION

This application claims the benefit of U.S. Provisional Application No. 61/392,989 filed on Oct. 14, 2010, entitled “TMC.”

### BACKGROUND OF THE INVENTION

1. Field of the Invention

The present invention relates to a tape measure holder device that allows for both ease of removal and ease of securing. The present invention further provides a means of attachment to a plurality of different belt types and preferences of attachment.

Tape measures are measurement tools utilized by many construction and home repair professionals and individuals that allow for a condensed means of measuring accurate lengths. These devices generally comprise a wound spool of flexible tape with graduated markings thereon for measurement of lengths and distances. The wound spool is secured within a housing, which further comprises a belt clip and means for controlling the tape position. The belt clip is utilized for securing the assembly over a user's belt for improved carrying and accessed when necessary. However, the act of retrieving and replacing the tape measure clip onto a belt can be difficult, time consuming and frustrating, especially if the user is engaged in other simultaneous activities that require the use of his or her hands. It is therefore contemplated that a need arises for a device that improves the quickness with which accessing and replacing a tape measure onto a belt is performed and eliminates work stoppages while searching for a tape measure.

In the past a variety of tools have been used for the purpose of supporting tape measures on a user's person. Some of these apparatuses allow for a support structure in a basket configuration, while others employ a hook configuration to hold the tape measure against a user. Unfortunately with these devices a user may still struggle to release the tape measure when needed, which can result in loss of productivity or unnecessary hassle. To use the device, a user must release the tape measure from the holder to allow for the extension of the tape. Following its use, replacement is often difficult, as the gap between a user's belt and his or her body is not suited for easy insertion of the belt clip.

The present invention solves these problems by providing a means for a tape measure to be secured by a holder, while still maintaining ease of release and replacement when needed. The present invention provides an offset from a user's belt that allows for easy access to the tape measure while in operation. It is designed to accept a tape measure belt clip thereon, eliminating the current problems associated with tape measure belt clips and directly connecting the device to one's belt. It further allows a user to utilizing the tape measure directly from the holder if desired.

2. Description of the Prior Art

The prior art contains a variety of devices for holding a tape measure and being able to attach the holder to an article of clothing on the user or a means of attaching a tape measure onto an article of clothing on the user by itself. These devices have familiar design and structural elements for the purposes of supporting tape measures. All prior art for holders of tape measures are structured by using a hook or basket configuration to secure the tape measure. If a clip is included in the prior art, it is created by including a strip of steel folded over to form a spring. These devices are not structured to provide a simple way of securing a tape measure and holder to a user's belt, and further do not provide an offset for the tape measure clip attachment that allows for ease of removal and replacement.

U.S. Pat. No. 4,598,027 to Johnson discloses a holster facilitating the carrying of a housing enclosed tape measure, a blank for forming the holster and a method of forming the holster. Side walls are formed extending from the edges of the rear wall, and front flaps are formed on the edges of each side wall with the front flaps dimensioned to permit the passage of a finger there between. A retaining means is attached to the rear wall of the holster for selectively securing said holster to a support. This retaining means can be obtained by sliding a belt through the loop formed by a strip on the rear wall, or by clipping the holster over the waistband of the user. By using one clip, the holster can possibly tilt while the user is in motion. There is an upturned lip flange section to the clip portion that forces the user to adjust the holster in order to release the holster from the user's apparel. Also, if the user is wearing gloves, it may be difficult to locate and remove the tape measure from the housing.

U.S. Pat. No. 4,897,898 to Chapin describes an adjustable tape measure clip which includes a strip of spring steel folded over to form a primary spring with opposing leaves, the inner leaf being adapted for attachment to the case of the tape measure. A mounting screw mounts the spring clip onto the case of the tape measure. This clip leaves the tape measure too close to the user's side to be able to release comfortably. The single clip itself will secure either too tightly or with the possibility of tilting while the user is in motion.

U.S. Pat. No. 7,131,214 to Blackman describes a mounting clip assembly for a tape measure having a lever arm coupled to a base plate for movement about a pivot axis between a closed and open position. A fastener is necessary to connect to a tape measure. The housing of the tape measure may get in the way of the clip while in the process of securing the tape measure. The single mounting clip will secure either too tightly or with the possibility of tilting while the user is in motion. The single mounting clip has a lip flange which forces the user to adjust for removal.

U.S. Published Patent Application, Publication No. 2004/0140337 to Rashleigh is an extension to be used with personal use devices having an integral belt clip, so that a personal use device may be clipped to the belt clip extension and be suspended from the belt of the user. The extension allows for free movement of the personal use device being held. The extension wraps around the belt, therefore does not allow for easy removal from belt. The extension also makes the tape measure difficult to collect since it is outside of a normal arm's distance. The user needing to raise and bend the knee of the leg of which the device is being held in order to retrieve it.

U.S. Design Pat. No. D443199 to Swanson details a stationary clip holder for a tape measure with a belt clip design. The clip holder is meant to be mounted to a vertical mounting surface with a pair of threaded fasteners. This design is meant to provide a stationary holder for a tape measure. This is designed to make the holder a fixture rather than a device that is portably accessible.

U.S. Pat. No. 6,095,455 to Green describes a tape roll carrier. An attachment mechanism fixed to a side of the backing plate has an open and closed position facilitating attachment and engagement of the apparel. The attachment mechanism has a lip flange which forces the user to adjust for removal. The support structure has a basket or hook configuration that may accommodate tape rolls of different widths.

U.S. Pat. No. 5,379,490 to Wandt discloses a belt clip assembly for portable electronic products. The assembly has a hook shaped feature that appends from a housing unit, a latch member pivotably retained within the void of the hook shape feature, and a spring for biasing a bottom portion of the latch member in a closed position against the housing. The single hook shaped feature will secure either too tightly or with the possibility of tilting while the user is in motion. The user has to adjust the hook shaped feature to release the belt clip assembly thereby adding an additional step to the releasing process.

The devices disclosed in the prior art do not address the need for stability, ease of transfer of both the belt clip and the tape measure or the ability to use the tape measure while in the holder. The current invention relates to a device that allows a user to quickly and easily access their tape measure while completing a project, releasing the tape measure by sliding the tape measure from the holder and replacing the tape measure with ease after its use. It substantially diverges in design elements from the prior art by the style of attachment and consequently it is clear that the present invention is not described by the prior art. There exists a need for an improved tape measure holder device that provides an efficient method of retaining a tape measure with easy access and easy replacement while working a project. In this regard the instant invention substantially fulfills these needs.

### SUMMARY OF THE INVENTION

In view of the foregoing disadvantages inherent in the known types of tape measure holders now present in the prior art, the present invention provides a new means to support the tape measure wherein the same can be easily accessed for use and replaced after use with minimal effort.

It is therefore an object of the present invention to provide a new and improved tape measure holder device that has all of the advantages of the prior art and none of the disadvantages.

Another object of the present invention is to provide a new and improved tape measure holder device that provides a quick attachment and release means for a tape measure by providing a horizontal shelf that is offset from a user's belt, which allows a user to easily secure a tape measure clip thereto. The offset further allows a user the ability to replace the tape measure after its use without viewing the engagement.

Yet another object of the present invention is to provide a new and improved tape measure holder device that can be attached to the belt by two bracket arms providing a stable, secure and easily removable placement on the belt of the user.

Another object of the present invention is to provide a new and improved tape measure holder device that can be attached to a user's belt using an alternative attachment means, comprising two bracket arms that allow a user's belt to slide therethrough.

Another object of the present invention is to provide a new and improved tape measure holder device with a second alternative belt attachment means, comprising a larger loop or plurality of loops that allow for engagement of a larger carpenter's belt.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front view of a preferred embodiment of the present invention.

FIG. 2 shows a rear view of a preferred embodiment of the present invention.

FIG. 3 shows a perspective view of a preferred embodiment of the present invention.

FIG. 4 shows a side view of a preferred embodiment of the present invention.

FIG. 5 shows a side view of a second embodiment of the present invention.

FIG. 6 shows a rear view of the second embodiment of the present invention.

FIG. 7 shows an overhead view of a preferred embodiment of the present invention.

### DETAILED DESCRIPTION OF THE INVENTION

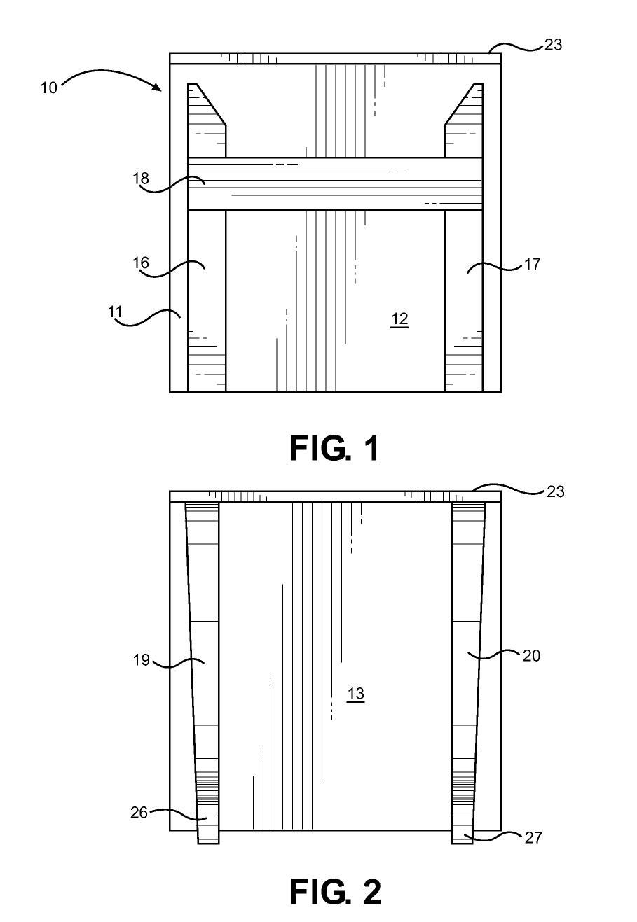

Referring now to FIG. 1, there is shown the tape measure holder device of the present invention in an unattached position. The device comprises a planar backing plate 11 with a front side 12 and a rear side 13. The front side of the backing surface 12 includes two vertical arms 17 that form a slot for which to place a tape measure clip between. Oriented perpendicular to the arms and located towards the top portion of the plate is a horizontal shelf 18 that connects both arms 17 together and forms a support bridge for which to rest the base of a tape measure clip thereagainst. The shelf 18 acts as a bearing member for which to support the tape measure while engaged with the present invention. A user may attach a tape measure onto the shelf 18 in order to hold the tape measure in place while working. A user does this by placing the integral clip of a tape measure through the slot formed by the boundaries of the two arms 17, the backing plate 11 and the shelf member 18. The body of the tape measure rests along the outer surface of the shelf while engaged. Since the body of the tape measure is on the outside of the holder, it is easily accessible and possible to use while still attached to the device. A user may attach or remove the tape measure from the horizontal shelf 18 with little effort, as the offset between the shelf 18 and the front side backing surface 12 allows for easy engagement of a tape measure clip and easy removal thereof when desired, which improves the current method of engaging a user's belt directly with the tape measure clip. Once the tape measure is attached to the device, in order to remove the tape measure the user simply needs to slide the tape measure assembly upward to release the tape measure clip from the horizontal shelf 18.

Referring now to FIG. 2, there is shown a rear view of the tape measure holder of the present invention, wherein the preferred embodiment of the holder belt engagement means is illustrated. In this embodiment, a plurality of clips 19 is provided for attachment over a user's belt. The clips 19 attach to an upper shelf region 23 defined by a horizontal surface at the upper region of the planar backing plate 11. The clips extend downward to the base of the backing plate 11 and make contact with the rear surface 13 before bending away from the rear surface 13 in a flared termination. The contact region between the rear surface 13 and the backing plate 11 allows the clips 19 to slide over a belt and secure therearound, while the flared termination of the clips 19 facilitates engagement of the belt without requiring the user to force the clips 19 over the belt or lift them away from the rear surface to engage the belt. The use of more than one clip 19 provides stability for the tape measure and holder while attached to a belt. The clips 19 provide a spring like action when pulled away from the rear surface 13, similar to standard spring clip designs found in the art.

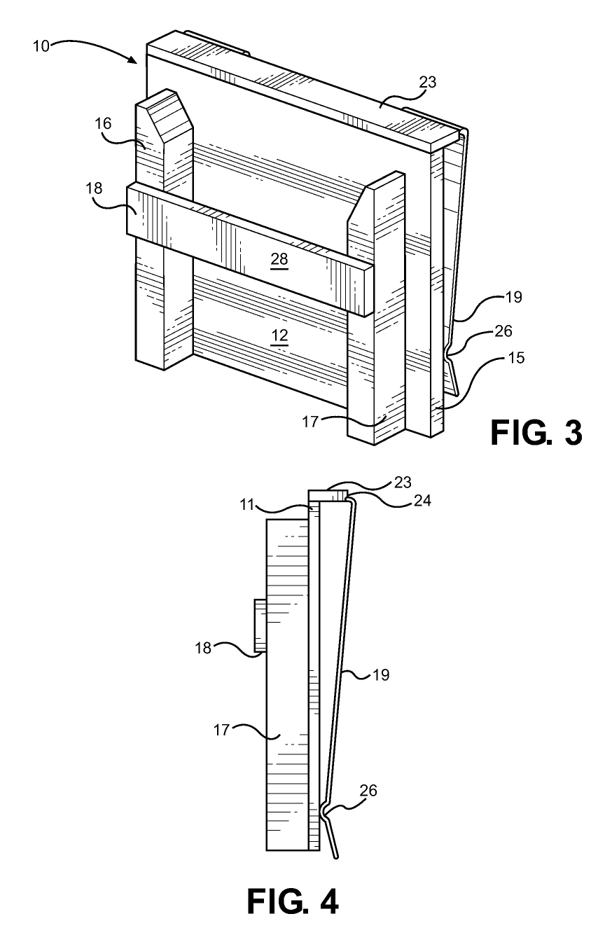

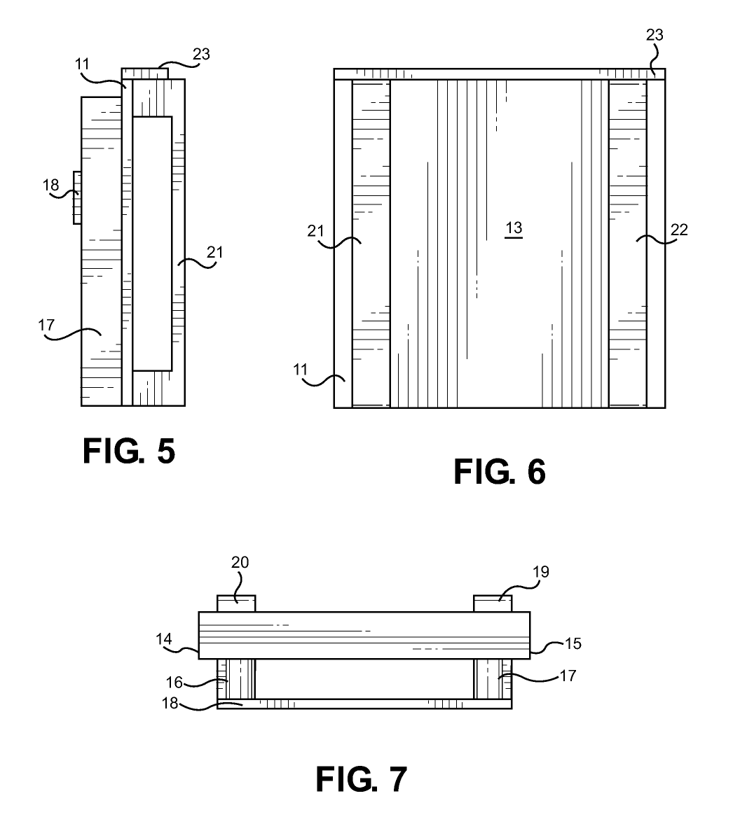

Referring now to FIG. 3 and FIG. 5, there is shown a perspective view and overhead view of the preferred embodiment of the tape measure holder, wherein the device is attachable to a user's belt using a plurality of clips 19. The two vertical arms 17 are shown attached to the front side 12 of the base plate 11, while a bridging horizontal shelf 18 attaches to the two vertical arms 17 to form a ledge for which to place a tape measure clip thereinto. The distance between the shelf 18 and the front surface 12 of the backing plate provides the offset for which a tape measure is held away from a user's body, allowing easy removal and replacement when desired and with minimal effort. It is also contemplated that the vertical arms 16 simply be offset posts for which to support the horizontal shelf 18 in a position that creates a ledge and slot defined by the shelf 18, arms and backing plate front surface 12. Along the upper portion of the device, the top shelf 23 is shown extending outward from the rear side of the plate 11 to affix the clips 19 that extend downward towards the base of the device, forming a means for which to engage a user's belt.

Referring now to FIG. 4, there is shown the tape measure holder device from a side view. The clips 19 attach to the upper shelf and extend towards the backing plate 11 to form a closed loop. The base of the clips 19 applies pressure to the belt when inserted into the space between the clips 19 and the plate 11, thereby securing the belt in place during operation and transport. The flared end of the clips allows for improved engagement of a user's belt.

An alternate embodiment of the present tape measure holder device is shown in FIG. 6 and FIG. 7 and includes an attachment means comprising a plurality of rectangular belt loops 21 for a belt to slide therethrough. In this embodiment, the user slides an end of his or her belt through the loops 21 of the device for secure and permanent attachment thereto. Adequate space within the loops 21 is provided for large belts, while the spacing between loops prevents rotation of the device when engaging or disengaging a tape measure clip along the front side of the device.

In another embodiment of the present invention, the belt attachment means along the back surface 13 of the device comprises a flexible and oversized loop for which to engage a carpenter's belt, or similarly tall belt that would otherwise be difficult to fit through the rigid loops 21 of the second embodiment. This third embodiment is ideal for those who wish to place the device on their utility belt for long term engagement, wherein the utility belt slides through the oversized loop in a similar fashion as the rigid loops 21, but with less restriction.

In use an individual engaging in a commercial or home improvement project may require a tape measure from time to time. In order to have a tape measure readily available for use when needed, the tape measure holding device is first attached to a user's belt using an appropriate attachment means. The tape measure clip can then be engaged over the shelf of the device and slid into the slot created by the vertical members and the backing plate. The offset distance between the shelf and the backing plate allows easy retrieval and replacement of the tape measure without requiring the user to observe the engagement, which greatly reduces his or her effort during these processes. The tape measure can also be utilized while still attached to the holder, if so desired. Overall, the device provides several different belt attachment means, which accommodate different geometry and style belts, while the tape measure clip engagement provides a novel means to attach a tape measure and provide access thereto.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A tape measure holder device for supporting a tape measure with integral clip, said device comprising:
a base plate with a front and rear surfaces;
a pair of vertical arms attached along said front surface;
a horizontal shelf attached to and bridging said vertical arms, said shelf providing a ledge to support said tap measure clip,
said base plate, vertical arms and horizontal shelf forming a slot for which to engage said tape measure clip;
a belt attachment means along said rear side of base plate.

2) The device of claim 1, wherein said horizontal shelf is positioned parallel to and offset from said front surface.

3) The device of claim 1, wherein said attachment means comprises a plurality of spring clips.

4) The device of claim 3, wherein said spring clips attach to an upper shelf attached to said base plate upper termination.

5) The device of claim 3, wherein said clips further comprise a flared termination to facilitate engagement of a user belt.

6) The device of claim 1, wherein said attachment means comprises a plurality of closed loops for the insertion of a belt therethrough.

7) The device of claim 1, wherein said attachment means comprises an oversized, flexible loop for engagement of a belt therethrough.

8) A tape measure holder device for supporting a tape measure with integral clip, said device comprising:
a base plate with a front and rear surfaces;
a pair of posts attached along said front surface and projected outward therefrom;
a horizontal shelf attached to and bridging said posts, said shelf providing a ledge to support said tap measure clip,
said base plate, posts and horizontal shelf forming a slot for which to engage said tape measure clip;
a belt attachment means along said rear side of base plate.

9) The device of claim 8, wherein said horizontal shelf is positioned parallel to and offset from said front surface.

10) The device of claim 8, wherein said attachment means comprises a plurality of spring clips.

11) The device of claim 10, wherein said spring clips attach to an upper shelf attached to said base plate upper termination.

12) The device of claim 10, wherein said clips further comprise a flared termination to facilitate engagement of a user belt.

13) The device of claim 8, wherein said attachment means comprises a plurality of closed loops for the insertion of a belt therethrough.

14) The device of claim 8, wherein said attachment means comprises an oversized, flexible loop for engagement of a belt therethrough.
